(19) United States
(12) Patent Application Publication
(10) Pub. No.: US 2014/0200918 A1
(43) Pub. Date: Jul. 17, 2014

(54) METHOD AND APPARATUS FOR SHARING HEALTH INFORMATION IN ACCORDANCE WITH DATA SHARING RULES

(71) Applicant: MCKESSON FINANCIAL HOLDINGS, Haimilton (BM)

(72) Inventor: Arien Malec, Oakland, CA (US)

(73) Assignee: McKesson Financial Holdings, Hamilton (BM)

(21) Appl. No.: 13/852,716

(22) Filed: Mar. 28, 2013

Related U.S. Application Data
(60) Provisional application No. 61/751,588, filed on Jan. 11, 2013.

(51) Int. Cl. G06Q 50/24; G06Q 10/00

(52) U.S. Cl. CPC G06Q 50/24; G06Q 10/00
USPC 705/3

(57) ABSTRACT

A method, apparatus and computer program product are provided to facilitate the sharing of health information between entities in accordance with data sharing rules effective for the entities. In the context of a method, a request is received to share health information of a patient between at least two entities. The method determines a data sharing group of which the at least two entities are members and determines data sharing rules for health information to be shared between members of the data sharing group of which the at least two entities are members. The method also shares the health information of the patient between the at least two entities in accordance with the data sharing rules.

### CROSS-REFERENCE TO A RELATED APPLICATION

This application claims the benefit of U.S. Provisional Application No. 61/751,588, filed Jan. 11, 2013, which is incorporated by reference herein in its entirety.

### TECHNOLOGICAL FIELD

An example embodiment of the present invention relates generally to the controlled sharing of health information between entities and, more particularly, to the sharing of health information in accordance with data sharing rules established between various entities.

### BACKGROUND

Health information exchanges have been established in order to control the sharing of health information between various entities, such as between hospitals, pharmacies, physicians, radiologists, other types of healthcare practices and the like. Although the care that may be provided for a patient by the various entities may be facilitated by the sharing of the patient's health information, the sharing of health information is generally limited for a variety of reasons including legal requirements and the privacy interests of the patients.

In this regard, patient consent is frequently required prior to sharing a patient's health information, thereby providing control and participation by the patient in conjunction with the sharing of their health information. However, health information exchanges generally apply the same consent requirements for all entities that are serviced by the health information exchange. For example, a health information exchange may offer the patients an opt-in type of consent such that the patient must affirmatively opt-in in order to permit their health information to be shared. With an opt-in type of consent, inaction by the patient effectively prevents sharing of the patient's health information. Opt-in consent therefore protects the patient's privacy at the expense of increased restrictions upon data sharing and associated care improvements that could be brought about by the sharing of the health information. Alternatively, a health information exchange may offer a patient an opt-out type of consent in which the patient is required to affirmatively opt-out in order to prevent their health information from being shared. An opt-out type of consent facilitates data sharing, but at the expense of patient privacy.

Regardless of the type of consent employed by a health information exchange, the utilization of a single type of consent for the sharing of health information between all of the entities that are serviced by the health information exchange may unnecessarily limit the health information that is shared, particularly since health information exchanges may service a wide variety of entities that may desire to share health information for various purposes associated with the patient's care.

### BRIEF SUMMARY

A method, apparatus and computer program product are provided in accordance with one embodiment to facilitate the sharing of health information between entities in accordance with data sharing rules effective for the entities. As such, data sharing rules may be utilized that are more specific or tailored for the entities seeking to share the health information such that the privacy interests of the patients are protected without unnecessarily encumbering data sharing between entities who are members of a data sharing group that is permitted to share health information in accordance with the data sharing rules.

In one embodiment, a method is provided that includes receiving a request to share health information of a patient between at least two entities. The method of this embodiment also determines a data sharing group of which the at least two entities are members and then determines data sharing rules for health information to be shared between members of the data sharing group of which the at least two entities are members. In this embodiment, the method also shares the health information of the patient between the at least two entities in accordance with the data sharing rules. In one embodiment in which the patient has an associated patient identifier, the method may also include associating the patient identifier of the patient with the health information of the patient maintained by one or more entities. In another embodiment, an apparatus comprising processing circuitry configured to perform comparable functionality is provided. In a further embodiment, a computer program product including at least one non-transitory computer-readable storage medium having computer-executable program code instructions stored therein that include program code instructions configured to perform comparable functionality is also provided.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of a system including a plurality of entities between which health information may be shared in accordance with an example embodiment of the present invention;

FIG. 2 is a block diagram of an apparatus that may be specifically configured in accordance with an example embodiment of the present invention;

FIG. 3 is a flow chart illustrating the operations performed, such as by the apparatus of FIG. 2, in accordance with an example embodiment of the present invention; and

FIG. 4 is an illustration of various data sharing groups of which the entities of FIG. 1 are members with the data sharing groups being utilized to direct the sharing of health information in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

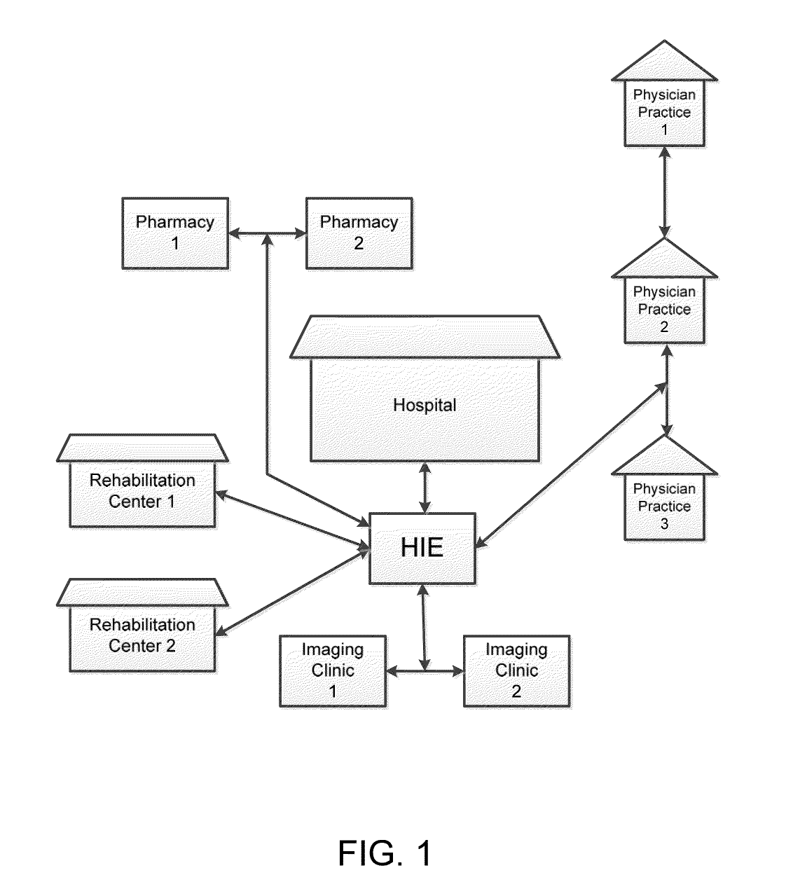

Referring now FIG. 1, a health information exchange (HIE) as well as a plurality of entities serviced by the health information exchange are depicted. The plurality of entities may include any entity that creates, collects, maintains, accesses or otherwise uses or shares health information. As such, FIG. 1 illustrates several examples of entities serviced by the health information exchange, but a health information exchange may service additional or different types of entities in other embodiments. Thus, the entities depicted in FIG. 1 are shown by way of example, but not of limitation. In any event, the health information exchange of FIG. 1 is in communication with a hospital, a plurality of physician practices, a plurality of imaging clinics, a rehabilitation center and a plurality of pharmacies.

The health information exchange may be embodied by a computing device 10, such as a server or the like. Although the health information exchange is shown in FIG. 1 to be separate from and in communication with the various entities, the health information exchange may be co-located with one or more of the entities in other embodiments. Additionally, while a single health information exchange is depicted in the embodiment of FIG. 1, the health information exchange may be decentralized and, in one embodiment, a plurality of entities may include a portion of the health information exchange functionality.

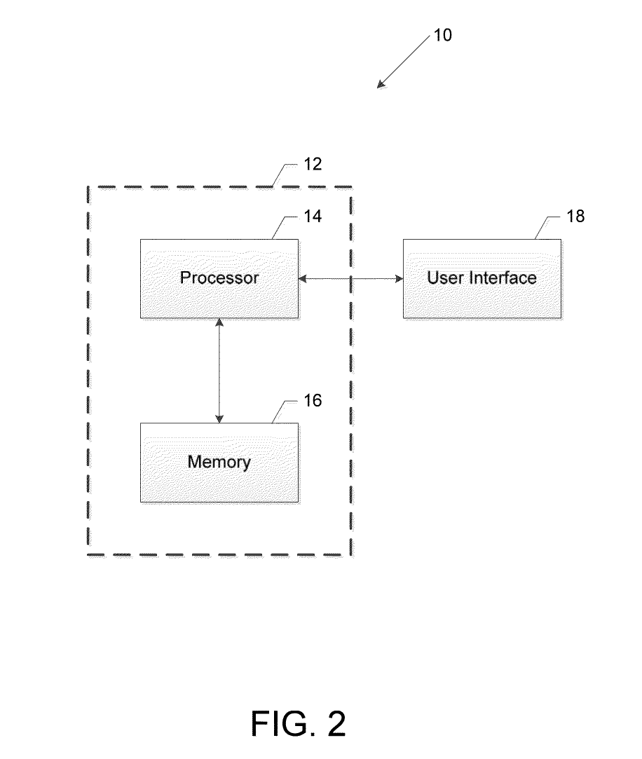

One example of a computing device 10 that embodies the health information exchange is depicted in FIG. 2 and may be specifically configured to perform various operations in accordance with an example embodiment of the present invention as described below. However, it should be noted that some embodiments may include further or different components, devices or elements beyond those shown and described herein, such as a user interface.

As shown in FIG. 2, the computing device 10 may include or otherwise be in communication with a processing system including, for example, processing circuitry 12 that is configurable to perform actions in accordance with example embodiments described herein. The processing circuitry may be configured to perform data processing, application execution and/or other processing and management services. The processing circuitry may include a processor 14 and memory 16 that may be in communication with or otherwise control a communication interface 18.

The communication interface 18 may include one or more interface mechanisms for enabling communication with the other entities. In this regard, the communication interface may include, for example, an antenna (or multiple antennas) and supporting hardware and/or software for enabling the communications, such as secure communications as noted above.

In an example embodiment, the memory 16 may include one or more non-transitory memory devices such as, for example, volatile and/or non-volatile memory that may be either fixed or removable. The memory may be configured to store information, data, applications, instructions or the like for enabling the computing device 10 to carry out various functions in accordance with example embodiments of the present invention. For example, the memory could be configured to buffer input data for processing by the processor 12. Additionally or alternatively, the memory could be configured to store instructions for execution by the processor.

The processor 12 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 14 or otherwise accessible to the processor. As such, whether configured by hardware or by a combination of hardware and software, the processor may represent an entity (e.g., physically embodied in circuitry—in the form of processing circuitry) specifically configured to perform operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

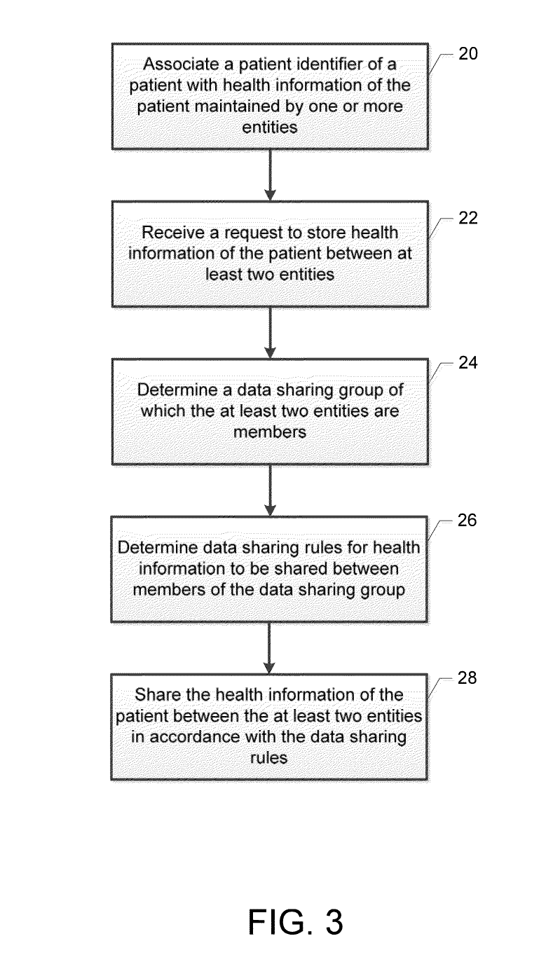

Referring now to FIG. 3, the operations performed by the computing device 10 that embodies the health information exchange are illustrated. The computing device, such as the processing circuitry 12 and, more particularly, the processor 14, may be configured to associate a patient identifier of a patient with health information of the patient maintained by one or more of the entities. See block 20 of FIG. 3. In this regard, the health information maintained by an entity with respect to a patient is generally associated with a patient identifier that uniquely identifies the patient. The patient identifier may universally identify the patient and, as such, may be utilized by each of the entities in association with the health information that is maintained for the same patient by the various entities. Alternatively, at least some of the entities may utilize different patient identifiers for the same patient. Regardless of whether the entities maintain the health information of a patient in conjunction with the same patient identifier or different patient identifiers (all of which are associated with and refer to the same patient), the processing circuitry, such as the processor, may be configured to associate the patient identifier(s) of the patient with the health information of the patient maintained by each of the entities. Thus, the health information of the patient that is maintained by each of the entities may be associated with the same patient such that the entity(ies) that maintain health information for the patient may be identified by the health information exchange, such as by the processing circuitry.

As shown in block 22 of FIG. 3, the computing device 10, such as the processing circuitry 12, e.g., the processor 14, or the communication interface 18, may receive a request to share health information of the patient between at least two of the entities serviced by the health information exchange. The request may be received from any of a variety of sources. For example, the request may be made by the patient who directs the sharing of health information between two or more of the entities, such as by directing the health information collected by an imaging clinic or a physician practice to be provided to the hospital in advance of a procedure. Alternatively, the request may be made by one of the entities that is desirous of obtaining health information of the patient from another one of the entities, such as in advance of an appointment by the patient or in conjunction with the rendering of a second opinion for the patient.

The computing device 10, such as the processing circuitry 12 and, more particularly, the processor 14, may also be configured to determine a data sharing group and, in one embodiment, a plurality of data sharing groups of which at least two entities are members. See block 24 of FIG. 3. The data sharing groups may be defined based upon a common set rules that have been adopted by the members of a group that define the manner in which healthcare information may be shared by the members of the group. Rules that define the manner in which healthcare information may be shared may be established in various circumstances, such as a result of business or legal relationships between the entities, as a result of membership within a care management organization or the like. While each entity is generally a member of at least one data sharing group, some of the entities may be members of two or more data sharing groups.

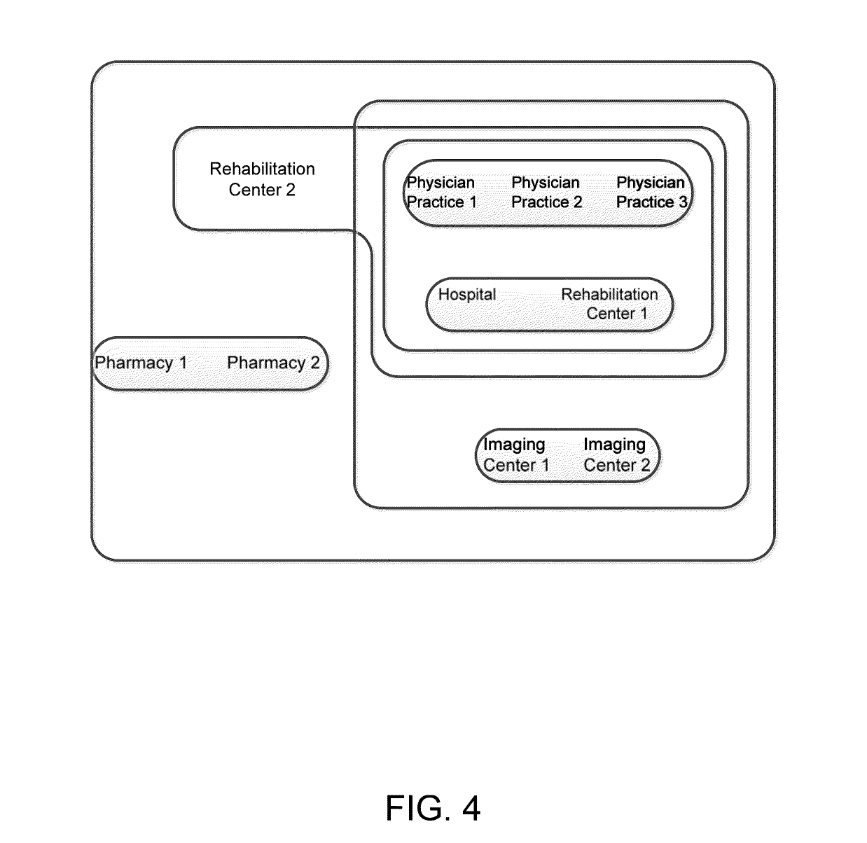

By way of example, but not of limitation, FIG. 4 illustrates the entities of FIG. 1 and the various data sharing groups in which the entities are members, as represented by the circles. For example, the three physician practices may be three offices of the same physician practice group. As such, the physician practices may be members of a data sharing group based upon the business and legal relationship between the physician practices. Additionally, rehabilitation center 1 may be a satellite facility of the hospital such that the hospital and rehabilitation center 1 may be members of the same data sharing group as a result of the business and legal relationship therebetween. In contrast, rehabilitation center 2 may not be a satellite facility of the hospital and, as such, may not be a member of the same small data sharing group as the hospital and rehabilitation center 1. However, rehabilitation center 2 may be part of the same care management organization that includes the physician practices, the hospital and rehabilitation center 1. Thus, a data sharing group may include the physician practices, both rehabilitation centers and the hospital as a result of their common affiliation with the same care management organization. The physician practices may also be associated with the hospital and rehabilitation center 1 and, in one instance, the physician practices may be owned by the same organization that owns the hospital and the rehabilitation center. As such, the physician practices and the hospital and the rehabilitation center may be part of a data sharing group.

Like the physician practices, the two imaging centers may be two offices of the same imaging center. Thus, the two imaging centers may be members of a data sharing group. Further, the imaging centers may have a business relationship with the hospital, rehabilitation center 1 and the physician practices so as to also be in a data sharing group with the hospital, rehabilitation center 1 and the physician practices. The pharmacies may similarly be related to one another, such as by the different branches of the same pharmacy. As such, the pharmacies may be members of a data sharing group. However, the pharmacies may not be under control of the care management organization that includes the hospital, the rehabilitation centers and the physician practices and, instead, may simply have a business relationship with those other entities regarding filling prescriptions that are written by healthcare practitioners working at those other entities. Thus, the pharmacies may also be within a data sharing group that includes all of the other entities of FIG. 1.

As noted above, the data sharing groups depicted in FIG. 4 are provided by way of example, but not of limitation as many other data sharing groups may be defined depending upon the relationships between the various entities in relation to the manner in which the privacy and confidentiality of the health information exchanged between the entities is to be maintained. In one embodiment, the smaller and more exclusive data sharing groups correspondingly have more specific agreements between the members as to the manner in which the health information may be shared and the manner in which the confidentiality of the health information is to be maintained, while the larger data sharing groups may have less formal agreements.

In regards to determining the data sharing group of which the at least two entities who are associated with the request to share health information are members, the computing device 10, such as the processing circuitry 12 and, more particularly, the processor 14, may determine the smallest data sharing group of which the at least two entities are determined to each be members. In this regard, as FIG. 4 illustrates, the entities may be members of a plurality of data sharing groups. However, the computing device, such as a processing circuitry and, more particularly, the processor, may determine the smallest data sharing group of which the at least two entities are each members to be the data sharing group that will service the request. For example, in an instance in which the request is to share health information from physician practice 1 to physician practice 3, the data sharing group that only includes the three physician practices would be determined to be the data sharing group, as opposed to the larger data sharing groups that include the hospital and the rehabilitation centers, the imaging centers or the pharmacies. As another example, in an instance in which the request is to share health information from pharmacy 1 to imaging center 1, the computing device, such as a processing circuitry and, more particularly, the processor, may determine the broadest data sharing group to be the data sharing group that will service the request since the broadest data sharing group is the only data sharing group that includes those two entities as members. Although the data sharing group may be determined to be the smallest data sharing group as described above, the data sharing group of which the at least two entities who are associated with the request to share health information are members may alternatively be defined in other manners, such as the data sharing group of which the at least two entities are determined to each be members that has the most restrictive sharing rules, the most specific sharing rules, etc.

As shown in block 26 of FIG. 3, the computing device 10, such as the processing circuitry 12 and, more particularly, the processor 14, may be configured to determine the data sharing rules for health information to be shared between members of the data sharing group. In this regard, the data sharing rules define the manner in which health information may be exchanged between members of a data sharing group and the manner in which the entities will protect the confidentiality of the health information including limitations, in some instances, upon further distribution of the health information. The data sharing rules may be stored, for example, by the memory 16 so as to be accessible by the processor once the data sharing group is determined.

The computing device 10, such as the processing circuitry 12, e.g., the processor 14, or the communication interface 18, may then share the health information of the patient between the at least two entities in response to the request in accordance with the data sharing rules associated with the data sharing group of which the at least two entities are members. Thus, the health information of the patient may be transmitted in the manner defined by the data sharing rules and each of the entities may be required to maintain the confidence and otherwise handle the health information of the patient according to the data sharing rules pre-established with respect to the respective data sharing group.

A method, apparatus and computer program product are therefore provided to facilitate the sharing of health information between entities in accordance with data sharing rules effective for the entities. Consequently, data sharing rules may be utilized that are more specific or tailored for the entities seeking to share the health information such that the privacy interests of the patients are protected without unnecessarily encumbering data sharing between entities who are members of a data sharing group that is permitted to share health information in accordance with the data sharing rules.

In one embodiment, a common data record containing the health information is maintained for each member of a data sharing group. In this embodiment, the data sharing rules may permit or require automatic updating of the health information. The data sharing rules may permit or require automatic updating of the health information for all or some of data records. For the data records to be automatically updated, the computing device 10, such as the processing circuitry 12, e.g., the processor 14, may maintain the health information up to date in a common data record that is accessible by all members of the data sharing group such that each member of the data sharing group will have access to the updated data record including the health information.

As noted above, FIG. 3 is a flowchart illustrating the operations performed by a method, apparatus and computer program product, such as computing device 10 of FIG. 2, in accordance with one embodiment of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 16 of a computing device employing an embodiment of the present invention and executed by a processor 14 of the computing device. As will be appreciated, any such computer program instructions may be loaded onto a computer or other programmable apparatus (e.g., hardware) to produce a machine, such that the resulting computer or other programmable apparatus provides for implementation of the functions specified in the flowchart blocks. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. As such, the operations of FIGS. 3 and 4, when executed, convert a computer or processing circuitry into a particular machine configured to perform an example embodiment of the present invention. Accordingly, the operations of FIG. 3 define an algorithm for configuring a computer or processing circuitry, e.g., processor, to perform an example embodiment. In some cases, a general purpose computer may be provided with an instance of the processor which performs the algorithm of FIG. 3 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions. In some embodiments, certain ones of the operations above may be modified or further amplified and additional optional operations may be included. It should be appreciated that each of the modifications, optional additions or amplifications below may be included with the operations above either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving a request to share health information of a patient between at least two entities;
determining a data sharing group of which the at least two entities are members;
determining data sharing rules for health information to be shared between members of the data sharing group of which the at least two entities are members; and
sharing the health information of the patient between the at least two entities in accordance with the data sharing rules.

2. A method according to claim 1 wherein the patient has an associated patient identifier, and wherein the method further comprises associating the patient identifier of the patient with the health information of the patient maintained by one or more entities.

3. A method according to claim 1 wherein determining a data sharing group of which the at least two entities are members comprises:
determining a plurality of data sharing groups of which the at least two entities are members; and
determining one of the plurality of data sharing groups to establish the data sharing rules.

4. A method according to claim 3 wherein determining one of the plurality of data sharing groups comprises determining a smallest of the plurality of data sharing groups of which the at least two entities are members.

5. A method according to claim 4 wherein determining data sharing rules comprises determining the data sharing rules for the smallest of the plurality of data sharing groups of which the at least two entities are members.

6. A method according to claim 1 wherein determining the data sharing rules comprises accessing the data sharing rules stored by memory.

7. A method according to claim 1 wherein the data sharing rules are established as a result of business or legal relationships between the members.

8. An apparatus comprising processing circuitry configured to:
receive a request to share health information of a patient between at least two entities;
determine a data sharing group of which the at least two entities are members;
determine data sharing rules for health information to be shared between members of the data sharing group of which the at least two entities are members; and
share the health information of the patient between the at least two entities in accordance with the data sharing rules.

9. An apparatus according to claim 8 wherein the patient has an associated patient identifier, and wherein the processing circuitry is further configured to associate the patient identifier of the patient with the health information of the patient maintained by one or more entities.

10. An apparatus according to claim 8 wherein the processing circuitry is configured to determine a data sharing group of which the at least two entities are members by:
determining a plurality of data sharing groups of which the at least two entities are members; and
determining one of the plurality of data sharing groups to establish the data sharing rules.

11. An apparatus according to claim 10 wherein the processing circuitry is configured to determine one of the plurality of data sharing groups by determining a smallest of the plurality of data sharing groups of which the at least two entities are members.

12. An apparatus according to claim 11 wherein the processing circuitry is configured to determine data sharing rules by determining the data sharing rules for the smallest of the plurality of data sharing groups of which the at least two entities are members.

13. An apparatus according to claim 8 wherein the processing circuitry is configured to determine the data sharing rules by accessing the data sharing rules stored by memory.

14. An apparatus according to claim 8 wherein the data sharing rules are established as a result of business or legal relationships between the members.

15. A computer program product comprising at least one non-transitory computer-readable storage medium having computer-executable program code instructions stored therein, the computer-executable program code instructions comprising:
program code instructions configured to receive a request to share health information of a patient between at least two entities;
program code instructions configured to determine a data sharing group of which the at least two entities are members;
program code instructions configured to determine data sharing rules for health information to be shared between members of the data sharing group of which the at least two entities are members; and
program code instructions configured to share the health information of the patient between the at least two entities in accordance with the data sharing rules.

16. A computer program product according to claim 15 wherein the patient has an associated patient identifier, and wherein the computer-executable program code instructions further comprise program code instructions configured to associate the patient identifier of the patient with the health information of the patient maintained by one or more entities.

17. A computer program product according to claim 15 wherein the program code instructions configured to determine a data sharing group of which the at least two entities are members comprise program code instructions configured to:
determine a plurality of data sharing groups of which the at least two entities are members; and
determine one of the plurality of data sharing groups to establish the data sharing rules.

18. A computer program product according to claim 17 wherein the program code instructions configured to determine one of the plurality of data sharing groups comprise program code instructions configured to determine a smallest of the plurality of data sharing groups of which the at least two entities are members.

19. A computer program product according to claim 18 wherein the program code instructions configured to determine data sharing rules comprise program code instructions configured to determine the data sharing rules for the smallest of the plurality of data sharing groups of which the at least two entities are members.

20. A computer program product according to claim 15 wherein the program code instructions configured to determine the data sharing rules comprise program code instructions configured to access the data sharing rules stored by memory.
